(19) United States
(12) Patent Application Publication
(10) Pub. No.: US 2014/0119019 A1
(43) Pub. Date: May 1, 2014

(54) STAGE LIGHT

(71) Applicant: Hui Lien Science And Technology Co., Ltd., Taoyuan County (TW)

(72) Inventor: Shu-Cheng HSU, Taoyuan County (TW)

(73) Assignee: Hui Lien Science And Technology Co., Ltd., Taoyuan County (TW)

(21) Appl. No.: 13/948,379

(22) Filed: Jul. 23, 2013

(30) Foreign Application Priority Data
Oct. 25, 2012 (TW) 101220623

(51) Int. Cl. F21S 10/00

(52) U.S. Cl. CPC F21S 10/00
USPC 362/269

(57) ABSTRACT

A stage light includes a base, a housing pivoted on the base, a lighting module, an emitting lens, a dimming module, a light-convergent assembly, and a prism. The housing includes an accommodating chamber and an opening communicating with the accommodating chamber. The lighting module is disposed within the accommodating chamber and includes a heat-dissipating element, a lighting assembly, an optical lens, and a diffuser. The heat-dissipating element includes a heat-conductive block fixed on the housing and at least one heat pipe penetrating the heat-conductive block. The lighting assembly includes a circuit board fixed on the heat-conductive block and a plurality of LEDs with different colors mounted on the circuit board. The optical lens and the diffuser are disposed corresponding to the LEDs. The emitting lens covers the opening. The dimming module, the light-convergent assembly, and the prism are located between the lighting module and the emitting lens.

### BACKGROUND OF THE INVENTION

1. Field of the Invention

The present invention relates to a lighting instrument, and in particular to an stage light.

2. Description of Related Art

In places of party, banquet or concert, stage light is used for producing lighting effect to make festive atmosphere and active scene. Therefore, stage light is indispensable for place with festivity. Currently, stage light can be separated into two categories: dynamic stage light and static stage light. The dynamic stage light can rotate and swing for making dynamic rhythm. The dynamic stage light is disposed on the ground of stage or hung on the wall for make atmosphere by changing or flickering light.

Conventional dynamic stage light is composed of a crystal stage light and a plurality of projecting lamps. The crystal stage light is hung on the ceiling, and the projecting lamps are embedded in the ceiling. The crystal stage light revolves on the rotary axis, and reflects light projected by projecting lamps to different directions, such that the stage light can achieve lighting effect by crossing reflection. However, the light colors of the stage light is controlled by the amount of the projecting lamps, the hue is limited thereof. Moreover, the reflected light is limited in a predetermined range (namely, light cannot transmit to every direction and every position of the place the stage light disposed), therefore the lighting effect of the stage light is excessively monotone and tough.

### SUMMARY OF THE INVENTION

It is an object to provide a stage light having lighting module, emitting lens, dimming module, light-convergence assembly, and prism. The lighting module, the emitting lens, the dimming module, the emitting lens, the light-convergent assembly, and the prism collectively provide dazzling, brilliant, and refined lighting effect.

Accordingly, the stage light according to one aspect of the present invention comprises a base, a housing, a lighting module, an emitting lens, a dimming module, a light-convergent assembly, and a prism. The housing is pivoted on the base. The housing comprises an accommodating chamber located therein and an opening communicating with the accommodating chamber. A hollow barrel extends inward from the opening and has an inner wall. The lighting module is disposed within the accommodating chamber. The lighting module comprises a heat-dissipating element, a lighting assembly, an optical lens, a diffuser, a micro structure, and a hollow body. The heat-dissipating element comprises a heat-conductive block fixed on the housing, at least one heat pipe penetrating the heat-conductive block, a plurality of fins, and at least one fan. The heat-pipe comprises at least one extending section exposed out of the heat-conductive block. The fins are serially connected to the extending section. The fan is fixed on the housing and disposed corresponding to the extending section. The lighting assembly comprises a circuit board and a plurality of LEDs. The circuit board is fixed on the heat-conductive block and disposed corresponding to the opening. The LEDs are mounted on the circuit board with stagger arrangement, each LED is RGB LED composed of red, green, and blue chip. The optical lens is disposed corresponding to the LEDs. The diffuser is disposed between the LEDs and the optical lens. The micro structure is formed on a surface of the optical lens, the surface adjacent to the diffuser. The hollow body is fixed on the heat-conductive block and surrounding the LEDs. The hollow body comprises an inner-ring wall, the optical lens and the diffuser are fixed on the inner ring wall. The emitting lens is fixed on the inner wall and covering the opening. The dimming module is fixed on the housing and located between the lighting module and the emitting lens. The dimming module comprises a revolving shelf and a plurality of plates, the revolving shelf is fixed on the housing, and the plates are assembled on the revolving shelf. The light-convergent assembly is fixed on the housing and located between the emitting lens and the dimming module. The light-convergence module comprises a raising shelf and at least one convergent lens, the raising shelf is fixed on the housing, the convergent lens is assembled on the raising shelf. The prism is fixed on the inner wall and located between the emitting lens and the light-convergent assembly.

The present invention has advantages as described below:

1. The lighting module, the emitting lens, the dimming module, the light-convergent assembly and the prism collectively adjust light emitted from the LEDs, such that light color can be changed and with function of converging light or diverging light. The housing is pivot on the base, therefore light refracted by the emitting lens can be moves or rotated by moving or rotating the housing, and the stage light can have dazzling, brilliant, and refined lighting effect.

2. The diffuser, the micro structure, the optical lens, the circuit board and the LEDs are stacked sequentially, such that light emitted from the LEDs can directly enter the diffuser, the micro structure, the optical lens and mix therein. Thus, the lighting module has an advantage of convenient light mixture.

3. The lighting module, the emitting lens, the dimming module, the convergent assembly, and the prism are stacked sequentially, such that the disposing locating thereof are easy, the space in the housing can be effectively used, and then the volume of the stage light can be effectively reduced.

4. The heat-dissipating element can dissipated heat generated by the LEDs via the heat-conductive block and the heat pipe, and the lighting module can have a good heat-dissipating effect.

5. The opposite sides of the LEDs disposed with the heat-dissipating fins and the fan, the heat-dissipating effect of the LEDs can be increased, and then increases the heat-dissipating efficiency of the lighting module.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is an assembly view of a stage light according to the present invention.

FIG. 2 is an assembly view of a lighting module according to the present invention.

FIG. 3 is a schematic view of a lighting assembly according to the present invention.

FIG. 4 is a perspective view of a dimming module according to the present invention.

FIG. 5 is a simulation diagram of the propagating of light in the stage light according to the present invention.

### DETAILED DESCRIPTION OF THE INVENTION

A preferred embodiment of the present invention will be described with reference to the drawings.

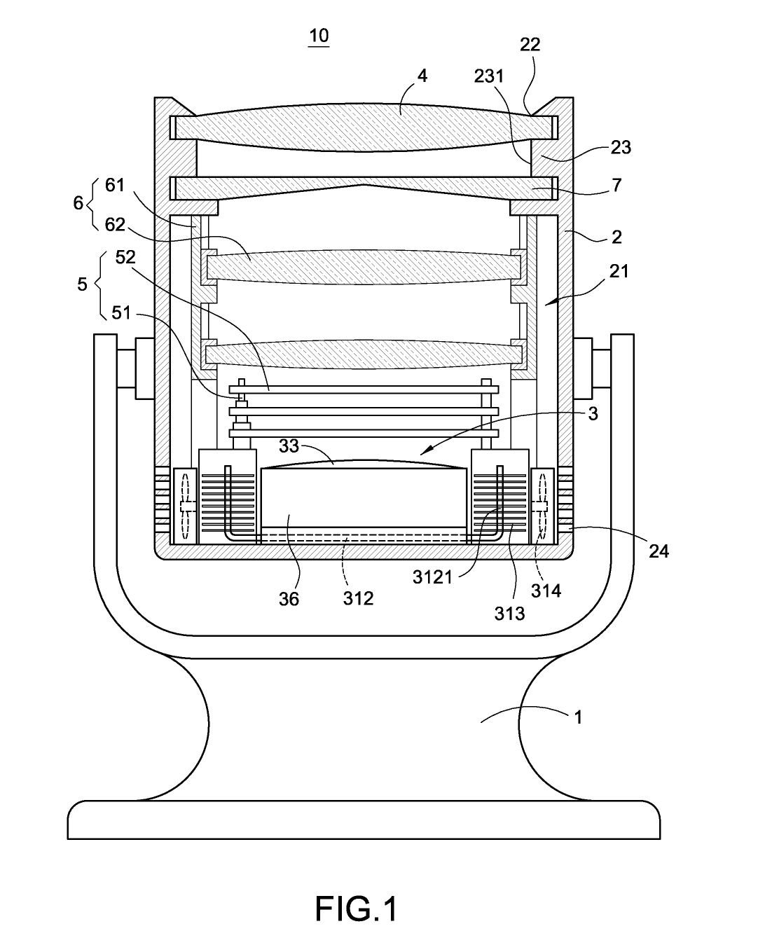

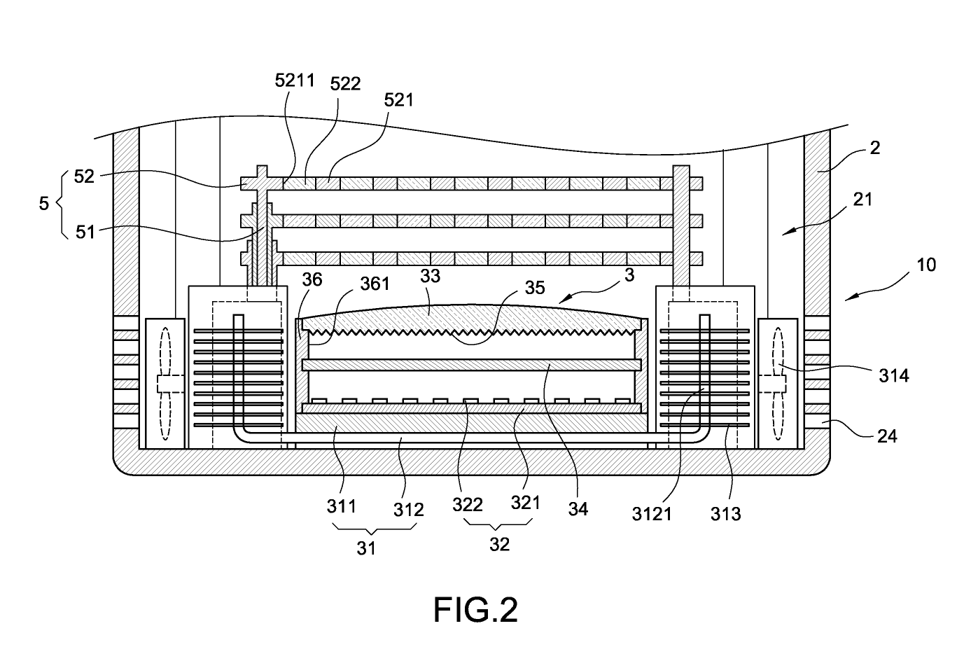

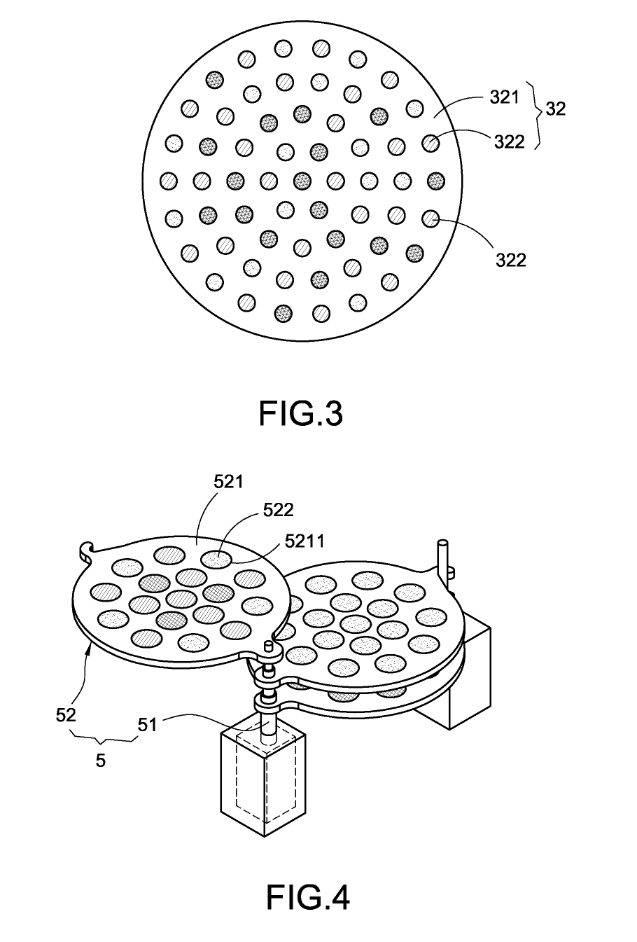

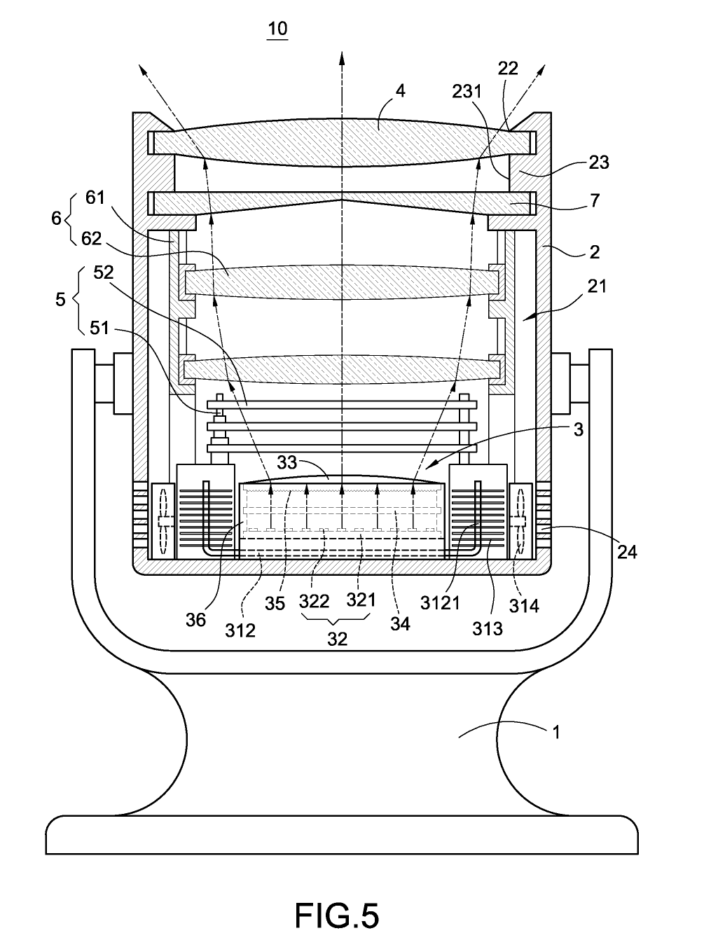

As shown in FIG. 1 to FIG. 5, a stage light 10 according to the present invention is provided. The stage light 10 includes a base 1, a housing 2, a lighting module 3, an emitting lens 4, a dimming module 5, a light-convergent assembly 6, and a prism 7.

The housing 2 is pivoted on the base 1. The housing 2 includes an accommodating chamber 21 disposed therein and an opening 22 communicating with the accommodating chamber 21. The housing 2 includes a hollow barrel 23 extending inward from the opening 22. The hollow barrel 23 includes an inner wall 231. The housing 24 also includes a plurality of ventilating grooves 24 disposed thereon.

The lighting module 3 is disposed within the accommodating chamber 21. The lighting module 3 includes a heat-dissipating element 31, a light emitting assembly 32, an optical lens 33, a diffuser 34, a micro structure 35, and a hollow body 36.

The heat-dissipating element 31 is fixed on the housing 2 and includes a heat-conductive block 311 and at least one heat pipe 312 penetrating through the heat-conductive block 311.

The heat-dissipating element 31 further includes a plurality of heat-dissipating fins 313 and two fans 314. The heat pipe 312 includes two extending sections 3121 exposed out of two sides of the heat-conductive block 311. The heat-dissipating fins 313 are serially connected to each extending section 3121. Each fan 314 is fixed on the housing 2 and disposed corresponding to each extending section 3121. Each ventilating groove 24 is corresponding to each fan 314.

The lighting module 32 includes a circuit board 321 corresponding to the opening 22 and a plurality of light emitting diodes (LEDs) 322 with different colors. The LEDs 332 are fixedly arranged on the circuit board 321 in interlaced arrangement (namely, the LEDs 332 are mounted on the circuit board 321 and disposed corresponding to the opening 22), such that light emitted from the LEDs 332 can be refracted by the optical lens 33. The optical lens 33 can have function of converging light or diverging light according to practical application. The diffuser 34 is located between the LEDs 332 and the optical lens 33. The diffuser 34 diffuses light emitted from the LEDs 332, and then diffused light enters the optical lens 33. The micro structure 35 is formed on a surface of the optical lens 33, and the surface is adjacent to the diffuser 3. The micro structure 35 scatters light, and then the scattered light can enter the optical lens 33 with different directions. The LEDs 332 with different colors are RGB LEDs composed of red, green, and blue chips interlaced on

The hollow body 36 is fixed on the heat-conductive block 311 and surrounds the LEDs 322. The hollow body 36 includes an inner-ring wall 361. The optical lens 33 and the diffuser 34 are fixed on the inner-ring wall 361, such that the light emitted from the LEDs 332 is surrounded by the hollow body 36 and converged on the optical lens 33 and the diffuser 34.

The emitting lens 4 is fixed on the housing 2 and covers the opening 22. The emitting lens 4 is fixed on the inner wall 231, and the emitting lens 4 can have function of converging light or diverging light according to practical application.

The dimming module 5 is fixed on the housing 2 and located between the lighting module 3 and the emitting lens 4. As shown in FIG. 4, the dimming module 5 includes a revolving shelf 51 and a plurality of plates 52 with a plurality of light-pervious holes 52. The revolving shelf 51 is fixed on the housing 2, and each plate 52 is assembled on the revolving shelf 51. The plate 52 includes a rotary disc 521 and a plurality of color sheets 522 with different colors. The rotary disc 521 includes a plurality of through-holes 5211. Each color sheet 522 is disposed on the rotary disc 521 and covers each through-hole 5211. Therefore, the light emitted from the LEDs 322 can be adjusted to different colors.

The light-convergent assembly 6 is fixed on the housing 2 and located between the emitting lens 4 and the dimming module 5. The light-convergent assembly 5 includes a raising shelf 61 and at least one convergent lens 62. In this embodiment, the amount of the convergent lens 62 is two. The raising shelf 61 is fixed on the housing 2, and each convergence lens 62 is assembled on the raising shelf 61. The raising shelf 61 can change the corresponding location or distance between the convergent lenses 62, and then a focal length of the LEDs 322 can be changed correspondingly.

The prism 7 is fixed on the housing 2 and located between the emitting lens 4 and the light-convergent assembly 6. In particularly, the prism 7 is fixed on the inner wall 231. The prism 7 can have function of converging light or diverging light according to practical application.

In the present invention, the housing 2 is pivoted on the base 1. The housing 2 includes the accommodating chamber 21 disposed therein and the opening 22 communicating with the accommodating chamber 21. The housing 2 also includes the hollow barrel 23 extending inward from the opening 22. The hollow barrel 23 includes the inner wall 231. The light module 3 is disposed within the accommodating chamber 21. The heat-dissipating element 31 includes the heat-conductive block 311 fixed on the housing 2 and the heat pipe 312 penetrates the heat-conductive block 311. The heat pipe 312 is exposed out of the extending sections 3121 of the heat-conductive block 311. The heat-dissipating fins 313 are serially connected to the extending sections 3121. The fans 314 are fixed on the housing 2 and disposed corresponding to the extending sections 3121. The lighting assembly 21 includes the circuit board 321 fixed on the housing 2 and the LEDs 322 with different colors fixedly arranged on the circuit board 321. Each LEDs 322 is RGB LED composed of red, green, and blue LED chips. The optical lens 33 is disposed on the LEDs 322. The diffuser 34 is disposed between the LEDs 322 and the optical lens 33. The micro structure 35 is formed on the surface of the optical lens 34 and adjacent to the diffuser 34. The hollow body 36 is fixed on the heat-conductive block 311 and surrounding the LEDs 322. The hollow body 36 includes the inner-ring wall 361. The optical lens 33 and the diffuser 34 are fixed on the inner-ring wall 361. The emitting lens 4 is fixed on the housing 2 and covers the opening 22. The dimming module 5 is fixed on the housing 2 and located between the lighting module 3 and the emitting lens 4. The dimming module 5 includes the revolving shelf 51 and the plates 52. The revolving shelf 51 is fixed on the housing 2. Each plate 52 is assembled on the revolving shelf 51. The convergent assembly 6 is fixed on the housing 2 and located between the emitting lens 4 and the dimming module 5. The light-convergent assembly 6 includes the raising shelf 61 and the convergent lenses 62. The raising shelf 61 is fixed on the housing 2, and the convergent lenses 62 are assembled on the raising shelf 61. The prism 7 is fixed on the inner wall 231 and located between the emitting lens 4 and the convergent assembly 6.

In usage, the lighting module 3, the emitting lens 4, the dimming module 5, the light-convergent assembly 6 and the prism 7 collectively adjust light emitted from the LEDs 322, such that light color can be changed and with function of converging light or diverging light. The housing 2 is pivot on the base 1, therefore light refracted by the emitting lens 4 can be moves or rotated by moving or rotating the housing 2, and the stage light 10 can have flourishing, dazzling, brilliant and refined lighting effect.

The diffuser 34, the micro structure 35, the optical lens 33, the circuit board 321 and the LEDs 332 are stacked sequentially, such that light emitted from the LEDs 322 can directly enter the diffuser 34, the micro structure 35, and the optical lens 33 and mix therein. Thus, the lighting module 4 has an advantage of convenient light mixture.

Also, the lighting module 3, the emitting lens 4, the dimming module, the convergent assembly 6, and the prism 7 are stacked sequentially, such that the disposing locating thereof are easy, the space in the housing 2 can be effectively used, and then the volume of the stage light 10 can be effectively reduced.

The heat-dissipating element 31 can dissipated heat generated by the LEDs 322 via the heat-conductive block 311 and the heat pipe 312, and the lighting module 4 can have a good heat-dissipating effect.

Moreover, the opposite sides of the LEDs 322 disposed with the heat-dissipating fins 313 and the fans 314, the heat-dissipating effect of the LEDs 322 can be increased, and then increases the heat-dissipating efficiency of the lighting module 3.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A stage light comprising:
a base;
a housing pivoted on the base, the housing comprising an accommodating chamber located therein and an opening communicating with the accommodating chamber, a hollow barrel extending inward from the opening and having an inner wall;
a lighting module disposed within the accommodating chamber, the lighting module comprising:
a heat-dissipating element comprising a heat-conductive block fixed on the housing, at least one heat pipe penetrating the heat-conductive block, a plurality of fins, and at least one fan, the heat-pipe comprising at least one extending section exposed out of the heat-conductive block, the fins serially connected to the extending section, the fan fixed on the housing and disposed corresponding to the extending section;
a lighting assembly comprising a circuit board and a plurality of light emitting diodes (LEDs), the circuit board fixed on the heat-conductive block and disposed corresponding to the opening, the LEDs mounted on the circuit board with stagger arrangement, each LED being RGB LED composed of red, green, and blue chip;
an optical lens disposed corresponding to the LEDs;
a diffuser disposed between the LEDs and the optical lens;
a micro structure formed on a surface of the optical lens, the surface adjacent to the diffuser; and
a hollow body fixed on the heat-conductive block and surrounding the LEDs, the hollow body comprising an inner-ring wall, the optical lens and the diffuser fixed on the inner ring wall;
an emitting lens fixed on the inner wall and covering the opening;
a dimming module fixed on the housing and located between the lighting module and the emitting lens, the dimming module comprising a revolving shelf and a plurality of plates, the revolving shelf fixed on the housing, the plates assembled on the revolving shelf;
a light-convergent assembly fixed on the housing and located between the emitting lens and the dimming module, the light-convergence module comprising a raising shelf and at least one convergent lens, the raising shelf fixed on the housing, the convergent lens assembled on the raising shelf; and
a prism fixed on the inner wall and located between the emitting lens and the light-convergent assembly.

2. The stage light in claim 1, wherein an amount of the extending sections and the fans is respectively two, the extending sections and the fans are disposed on two sides of the heat-conductive block, respectively.

3. The stage light in claim 2, wherein the housing comprises a plurality of ventilating grooves disposed corresponding to the fans.

4. The stage light in claim 1, wherein each plate comprises a rotary disc and a plurality of color sheets, the rotary disc comprising a plurality of through-holes, the color sheets are respectively disposed on the rotary disc and cover the through-holes.

5. The stage light in claim 1, wherein an amount of the light-convergent lens is two.
